(19) United States
(12) Patent Application Publication
(10) Pub. No.: US 2016/0132172 A1
(43) Pub. Date: May 12, 2016

(54) OBJECT DETERMINING METHOD AND TOUCH CONTROL APPARATUS

(71) Applicant: PixArt Imaging Inc., Hsin-Chu City (TW)

(72) Inventors: Tse-Chung Su, Hsin-Chu City (TW); Chi-Chieh Liao, Hsin-Chu City (TW)

(21) Appl. No.: 14/816,054

(22) Filed: Aug. 2, 2015

(30) Foreign Application Priority Data
Nov. 12, 2014 (TW) 103139271

(51) Int. Cl. G06F 3/041

(52) U.S. Cl. CPC G06F 3/0416; G06F 2203/04104

(57) ABSTRACT

An object state determining method, for determining a state for an object on a sensing surface of a touch control apparatus, comprising: (a) computing a sensing length according at least one touch sensing amount that the object causes to the sensing surface; (b) determining an object state of the object according to an arrangement of the sensing length. A touch control apparatus applying the object state determining method is also disclosed.

### BACKGROUND OF THE INVENTION

1. Field of the Invention

The present invention relates to an object determining method and a touch control apparatus, and particularly relates to an object determining method and a touch control apparatus which can avoid wrongly determining an object state.

2. Description of the Prior Art

In recent years, a touch control mouse is getting more and more popular and gradually replaces a mouse with buttons. However, for some cases, the error for wrongly determining the object state may happen.

FIG. 1 to FIG. 4 are schematic diagrams illustrating a finger slipping to a front part of a touch control mouse. In FIG. 1 to FIG. 4, a length of the sensing region in the lower figure corresponds to a finger length at a left side of the dotted line L in the upper figure. That is, even if the finger F does not touch the sensing surface but is away from the sensing surface in a predetermined distance, the sensing length also responds it. In FIG. 1 to FIG. 4, the sensing regions 103, 203, 303, 403 indicate states between the finger and the sensing surface 101 of the touch control mouse 100. The corresponding part of the sensing region 103 has a larger touch sensing amount (ex. brightness or a capacitance value variation), if any part of the finger F is closer to the sensing surface 101. The larger the touch sensing amount, the closer the oblique lines in the figures. If the sensing surface 101 applies a sensing mechanism which is capacitance/resistance sensing or a sensing mechanism using sensing matrixes, the sensing region 103 is an assemble for a plurality of sensing pixels (or more than one assembles for a plurality of sensing pixels), for example, neighbor pixels with touch sensing amounts larger than a threshold value. If the sensing surface 101 applies optical/infrared sensing ray mechanisms or applies sensing mechanisms without using sensing matrixes, which computes coordinates locations based on distribution for touch sensing amount in different dimensions, the sensing region 103 can be a sensing area based on performing intersection computing for the sensing amount in two dimensions. That is, the touch sensing amount can be pixel amounts/sensing region size for a pixel assemble, or a corresponding sensing value weighted summing/average in a pixel assemble/average.

In FIG. 1 the finger F tends to slip to a front part of the touch control mouse 100, and only a small part of the first finger section f1 touches the sensing surface 101. In such state, the sensing length for the sensing region 103 is shorter. Also, a touch sensing amount of the front part of the sensing region 203 (corresponding to the first finger section f1) is larger than the touch sensing amount of the rear part of the sensing region 203. Also, in the state of FIG. 2, the finger F has slipped forward for a short distance, thus the first finger section f1 has a larger part close to the sensing surface 101. In such case, the sensing length of the sensing region 203 is larger than which in FIG. 1. Also, the touch sensing amount of the front part of the sensing region 203 (corresponding to the first finger section f1) is larger than the touch sensing amount of the rear part of the sensing region 203 (closer oblique lines). Besides, the most front part of the finger may not completely touches the sensing surface 101, thus the touch sensing amount thereof may be smaller.

In FIG. 3, the finger F further moves toward, such that the first finger section f1 and part of the second finger section f2 tightly touches the sensing surface 101. Accordingly, the sensing length for the sensing region 303 in FIG. 3 is larger than which of the FIG. 2. Also, in such state, the second finger section f2 touches the sensing surface 101 more tightly, thus the part of the touch sensing region 303, which corresponds to the second finger section f2, has a larger touch sensing amount (the middle part and the rear part which have closer oblique lines).

In FIG. 4, the finger F has already accomplished the operation of moving toward. Thus, the first finger section f1 may stick up and only the second finger f2 touches the sensing surface 101 tightly. In such state, the front part of the sensing region 403 has a smaller touch sensing amount, and the rear part of the sensing region 403 has a larger touch sensing amount (corresponding to the second finger section f2).

However, in the process from FIG. 3 to FIG. 4, an error for wrongly determining the finger state may happen. For more detail, in FIG. 4, the first finger section f1 of the finger F has already left the sensing surface 101, which indicates the user does not want to perform a control action. However, in FIG. 4 the touch sensing amount for the second finger section f2 occupies a larger ratio for total touch sensing amount. Accordingly, a barycenter for the part that the finger F touches the sensing surface 101 moves back, such that the touch control mouse 100 may wrongly determine that the finger is slipping to a rear part of the mouse. On the opposite, if the finger tends to move from the front part to the rear part, the operation thereof is opposite the above-mentioned operations. Accordingly, in the process to FIG. 4 to FIG. 3, the finger state may be wrongly determined as well.

The above-mentioned issues are particularly serious if the touch control mouse has a curved sensing surface. Related technique provides a touch control mouse with a flatter touch sensing surface to solve such issues. However, a touch control mouse with a flatter touch sensing surface is not easy for a user to use it smoothly and comfortably.

### SUMMARY OF THE INVENTION

Therefore, one objective of the present invention is to provide an object state determining method that can avoid wrongly determining the object state.

Another objective of the present invention is to provide a touch control apparatus that can avoid wrongly determining the object state.

One embodiment of the present application discloses an object state determining method for determining a state for an object with respected to a touch sensing surface of a touch control apparatus. The method comprises: (a) computing a sensing length according to at least one touch sensing amount that the object causes to the sensing surface; (b) separating at least part of the sensing length to a front part region and a middle part region; (c) computing a front part touch sensing amount for the front part region; (d) computing a middle part touch sensing amount for the middle part region; and (e) determining an object state of the object according to the front part touch sensing amount and the middle part touch sensing amount.

Another embodiment of the present application discloses an object state determining method for determining a state for an object with respected to a touch sensing surface of a touch control apparatus. The method comprises: (a) computing a sensing length according to at least one touch sensing amount that the object causes to the sensing surface; (b) determining an object state of the object according to a relation between the sensing length and a state threshold length.

Another embodiment of the present application discloses an object state determining method for determining a state for an object with respected to a touch sensing surface of a touch control apparatus. The method comprises: (a) computing a first object region according to at least one first touch sensing amount that the object causes to the sensing surface; (b) computing a second object region according to at least one second touch sensing amount that the object causes to the sensing surface; (c) computing an object moving direction according to locations of the first object region and the second object region; and (d) determining an object state according to a relation between a size of the first object region, a size of the second object region, and the object moving direction.

Still another embodiment of the present invention discloses the touch control apparatus comprising a sensing surface, a touch sensing amount computing unit and a control unit. The touch sensing amount computing unit is arranged to compute at least one touch sensing amount according to a distance between the object and the sensing surface. The control unit is arranged to compute a sensing length, a moving state of the object or to determine an object state according to the touch sensing amount.

In view of above-mentioned embodiments, the issue for wrongly determining the object state can be avoided. Also, different sensitivities can be set for above-mentioned embodiments, thus the issue for wrongly determining the object state can be avoided more effectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 to FIG. 4 are schematic diagrams illustrating a finger slipping to a front part of a touch control mouse.

FIG. 5 to FIG. 9 are schematic diagrams illustrating a finger state detecting method according to one embodiment of the preset invention.

FIG. 10 to FIG. 13 are schematic diagrams illustrating a finger state detecting method according to another embodiment of the preset invention.

FIG. 14 to FIG. 15 are schematic diagrams illustrating a finger state detecting method according to still another embodiment of the preset invention.

FIG. 16 to FIG. 17 are schematic diagrams illustrating a finger state detecting method according to still another embodiment of the preset invention.

FIG. 18 is a block diagram illustrating a touch control apparatus according to one embodiment of the present invention.

### DETAILED DESCRIPTION

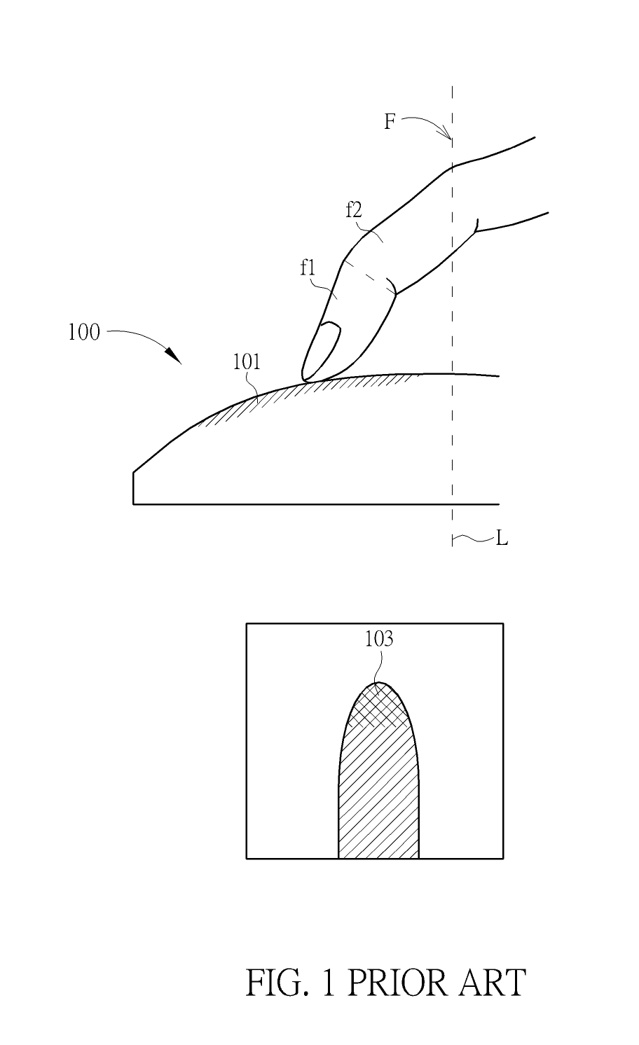

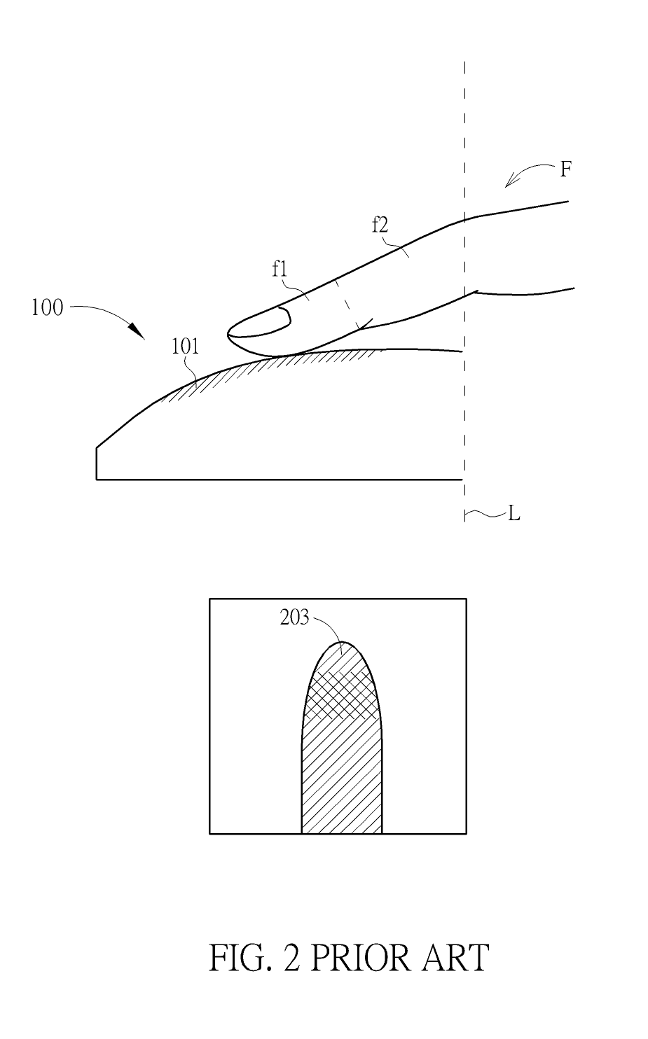

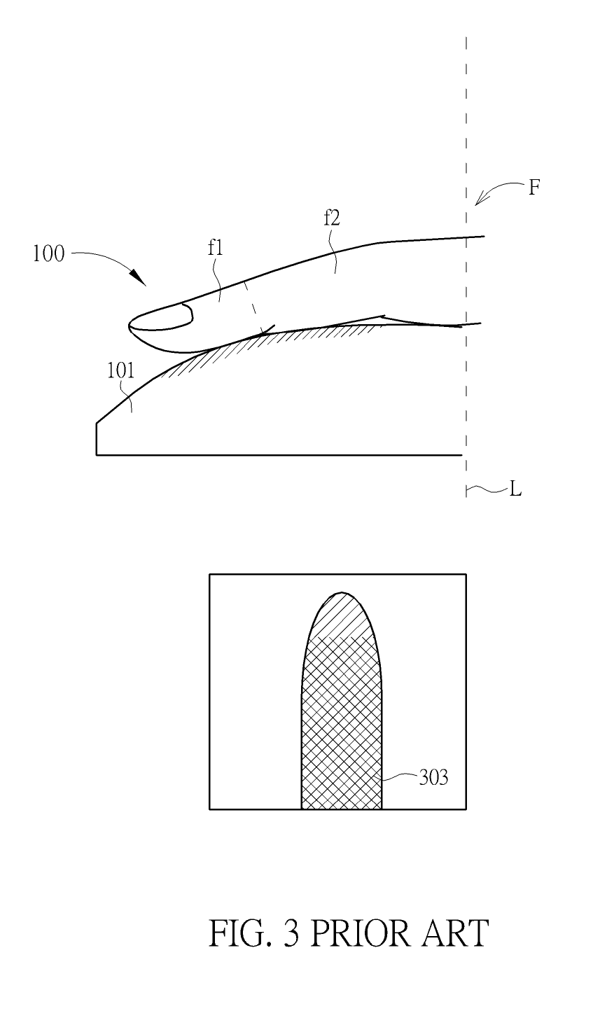

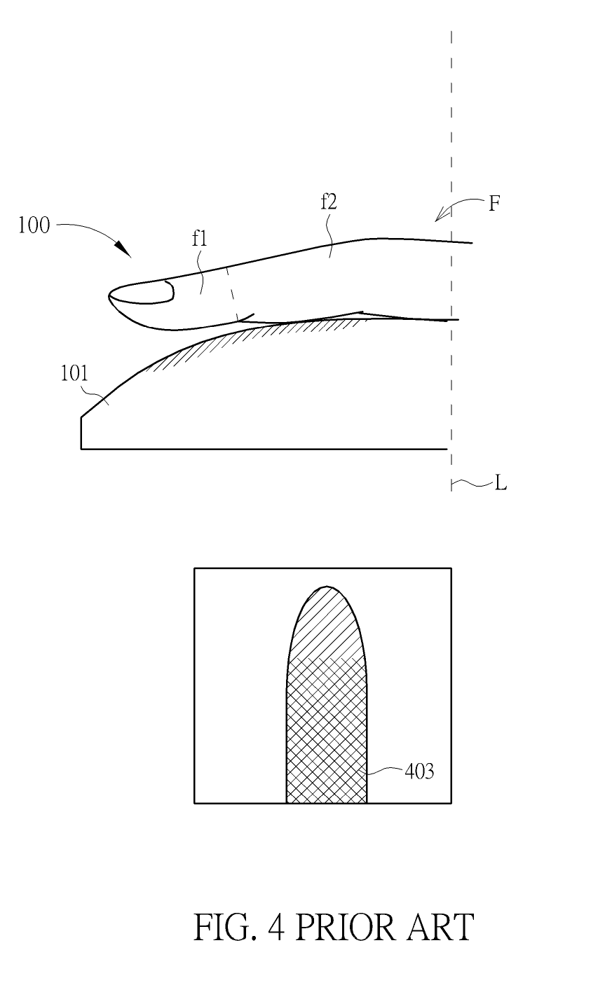

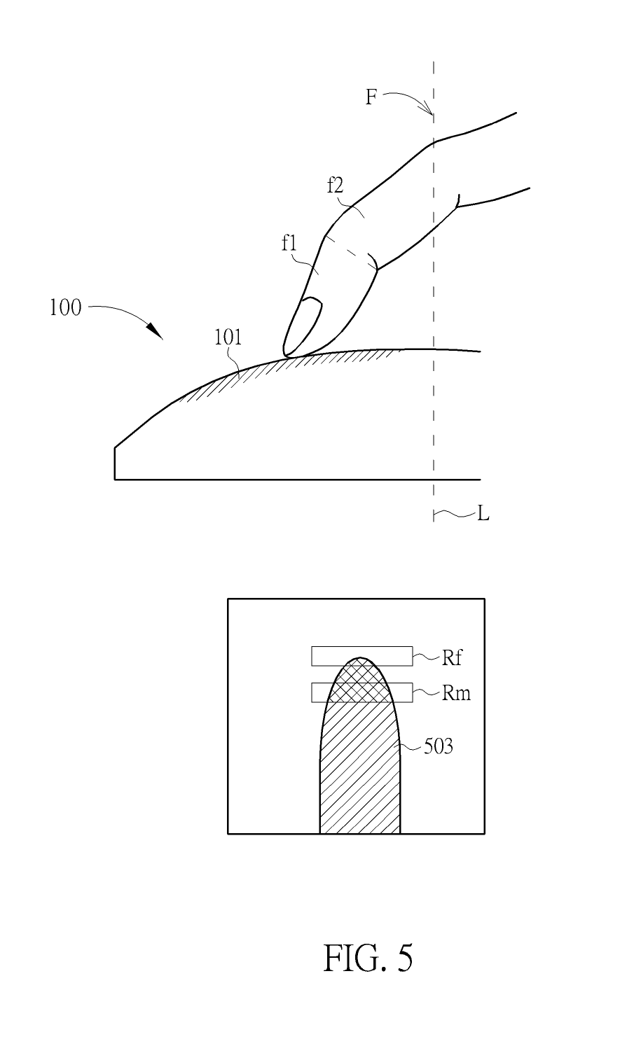

FIG. 5 to FIG. 9 are schematic diagrams illustrating a finger state detecting method according to one embodiment of the preset invention. The finger states in FIG. 5 to FIG. 8 are corresponding to which in FIG. 1 to FIG. 4, thus please refer decryptions related with FIG. 1 to FIG. 4 as well to understand the contents of FIG. 5 to FIG. 8. Similarly, in FIG. 5 to FIG. 8, a length of the sensing region in the lower figure corresponds to a finger length at a left side of the dotted line L in the upper figure. That is, even if the finger F does not touch the sensing surface but is away from the sensing surface in a predetermined distance, the sensing length also responds it. The sensing regions 503, 603, 703 and 803 are respectively separated into a front part region Rf and a middle part region Rm. In one embodiment, the front part region Rf comprises a fingertip, and the middle part region Rm the part of the fingertip which is closer to other finger sections and/or at least part for other finger sections. After that, the front part touch sensing amount S_Rf for the front part region Rf and the middle part touch sensing amount S_Rm for the middle part region Rm are acquired, and a ratio for these two touch sensing amounts are acquired. The above-mentioned touch sensing amounts are brightness values or capacitance variation values.

In one embodiment, if the touch sensing amount ratio

$$\frac{S\_Rm}{S\_Rf}$$

is larger than a state threshold value, it is determined that the object is in a non touch control state related with the sensing surface. On the opposite, if the touch sensing amount ratio

$$\frac{S\_Rm}{S\_Rf}$$

is smaller than a state threshold value, it is determined that the object is in a touch control state related with the sensing surface. If the touch sensing amount ratio

$$\frac{S\_Rm}{S\_Rf}$$

is equal to a state threshold value, it can be determined that the object is in the touch control state or the non touch control state related with the sensing surface. In one embodiment, the sensing regions 503, 603, 703, 803 . . . are generated by capacitance type touch control sensing matrix. Accordingly, the S_Rm or S_Rf for the touch sensing amount ratio is preferably an assemble for capacitance sensing values. The front part touch sensing amount S_Rf is a pixel amount for the pixel assemble for the front part region Rf, and the middle part touch sensing amount S_Rm is a pixel amount for the pixel assemble for the middle part region Rm. In another embodiment, the front part touch sensing amount S_Rf and the middle part touch sensing amount S_Rm can represent sensing amount information for at least one corresponding pixel assemble. For example, the brightness value sum or the average brightness value for all pixels of corresponding pixel assembles. In the following embodiments, the front part touch sensing amount S_Rf and the middle part touch sensing amount S_Rm are average sensing amounts for corresponding pixel assembles, but not limited.

For more detail, in the state of FIG. 5, only the fingertip of the finger F touches the sensing surface 101, the front part region Rf and the middle part region Rm are corresponding to the fingertip or regions closer to the fingertip. The distribution for the touch sensing amount is uniform. Accordingly, the front part touch sensing amount S_Rf and the middle part touch sensing amount S_Rm are similar thus the touch sensing amount ratio

$$\frac{S\_Rm}{S\_Rf}$$

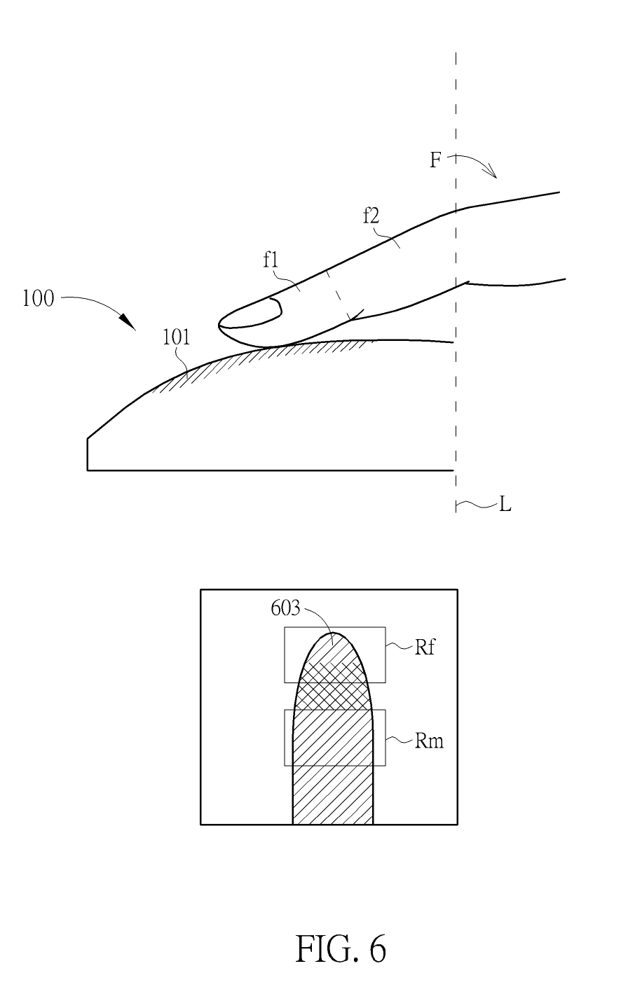

is smaller. In the state of FIG. 6, the front part region Rf corresponds to the fingertip and the middle part region Rm corresponds to a middle finger section. In such case, since the fingertip is closer to the sensing surface 101 than the middle finger section, the front part touch sensing amount S_Rf is larger than the middle part touch sensing amount S_Rm. By this way, the touch sensing amount ratio

$$\frac{S\_Rm}{S\_Rf}$$

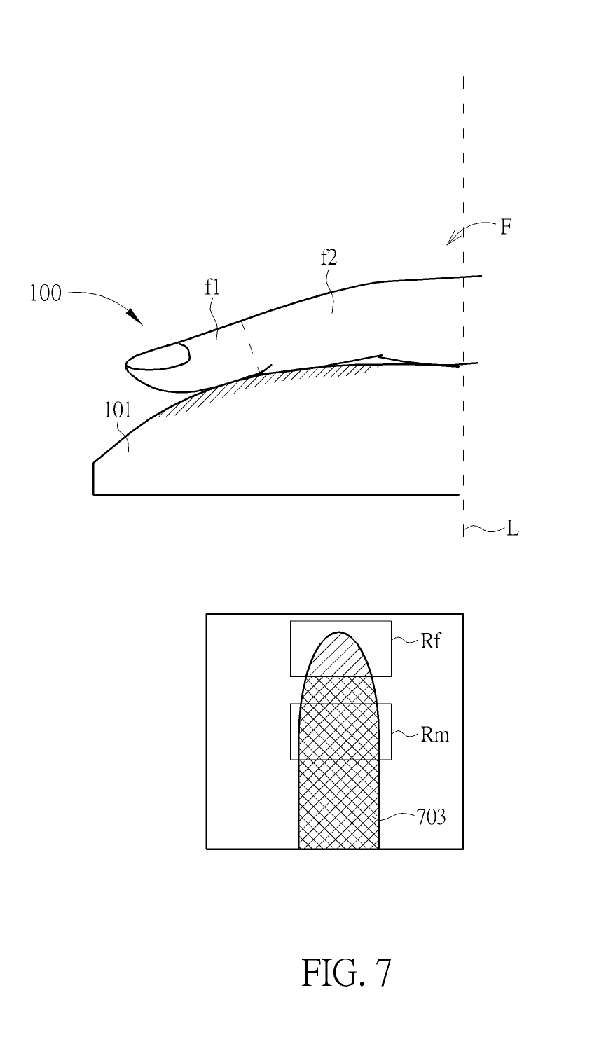

of FIG. 6 is smaller than which of FIG. 5. In the state of FIG. 7, the front part region Rf corresponds to the fingertip and the middle part region Rm corresponds to a middle finger section. In such case, since the middle finger section is closer to the sensing surface 101 than the fingertip, the middle part touch sensing amount S_Rm is larger than the front part touch sensing amount S_Rf. By this way, the touch sensing amount ratio

$$\frac{S\_Rm}{S\_Rf}$$

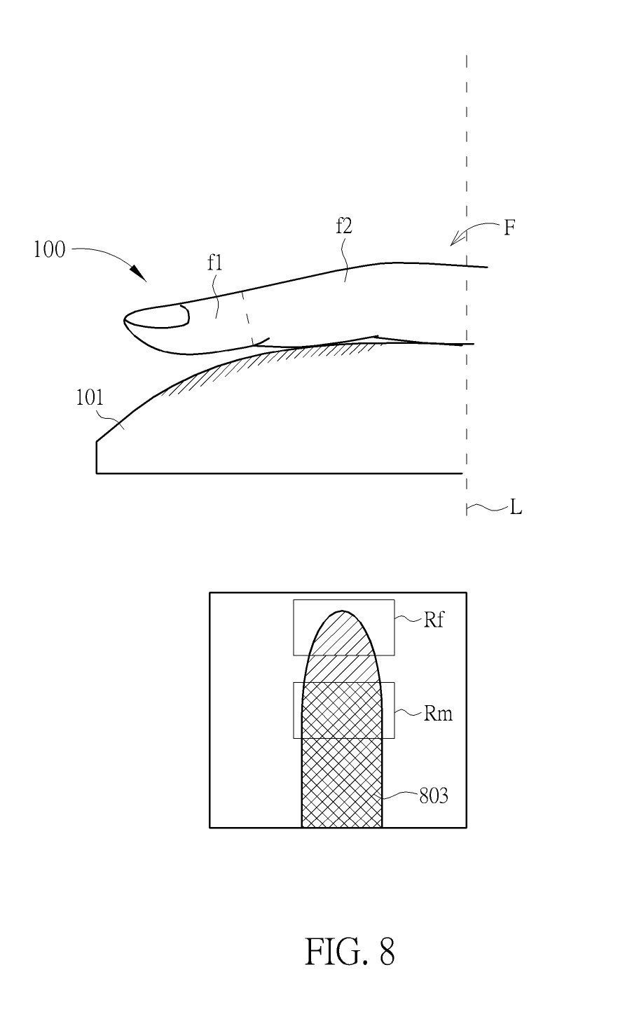

of the sensing region 703 is larger. Similarly, in the state of FIG. 8, the front part region Rf corresponds to the fingertip and the middle part region Rm corresponds to a middle finger section. In such case, the fingertip sticks up thus the middle finger section is closer to the sensing surface 101 than the fingertip. Accordingly, the middle part touch sensing amount S_Rm is larger than the front part touch sensing amount S_Rf. By this way, the touch sensing amount ratio

$$\frac{S\_Rm}{S\_Rf}$$

of the sensing region 803 is larger.

Based on FIG. 7 to FIG. 8, in some cases the finger keeps moving toward, but the barycenter for the touch image of the finger moves back (ex. to the wrist) since the surface of the mouse is curved. For more detail, the barycenter of the touch image is computed according to touch sensing amount of the finger while computing a touch location of the finger, and the barycenter is applied as the touch location of the finger. Based on FIG. 7 to FIG. 8, the finger keeps moving toward but the barycenter of the touch image moves back, thus the finger is wrongly determined to move back. Therefore, if it determined the finger is in a non touch control state if the touch sensing amount ratio

$$\frac{S\_Rm}{S\_Rf}$$

is larger than a state threshold value, and ignore any touch control operation that the finger performs to the sensing surface in a predetermined time period (which can be 0) for a timing that the finger is determined in a touch control state with respect to the sensing surface if the finger is determined to be in a non touch control state, the wrong determination for to process of FIG. 7 to FIG. 8, and FIG. 8 to FIG. 7 can be avoided. Please note, the mechanism for determining if the finger is in a touch control state or in a non touch control state is not limited to above-mentioned rules. For example, the touch sensing amount ratio

$$\frac{S\_Rm}{S\_Rf}$$

can be reversed to

$$\frac{S\_Rf}{S\_Rm} ,$$

and determine the finger is in a non touch control state if the

$$\frac{S\_Rf}{S\_Rm}$$

is smaller than a state threshold value. On the opposite, determine the finger is in a touch control state if the

$$\frac{S\_Rf}{S\_Rm}$$

is larger than a state threshold value. Such variation should also fall in the scope of the present invention.

In one embodiment, the touch control apparatus is a capacitance type touch control apparatus, wherein the touch sensing amount, the front part touch sensing amount and the middle part touch sensing amount are capacitance variation values. In another embodiment, the touch control apparatus is an optical touch control apparatus, wherein the front part touch sensing amount, and the middle part touch sensing amount are brightness values.

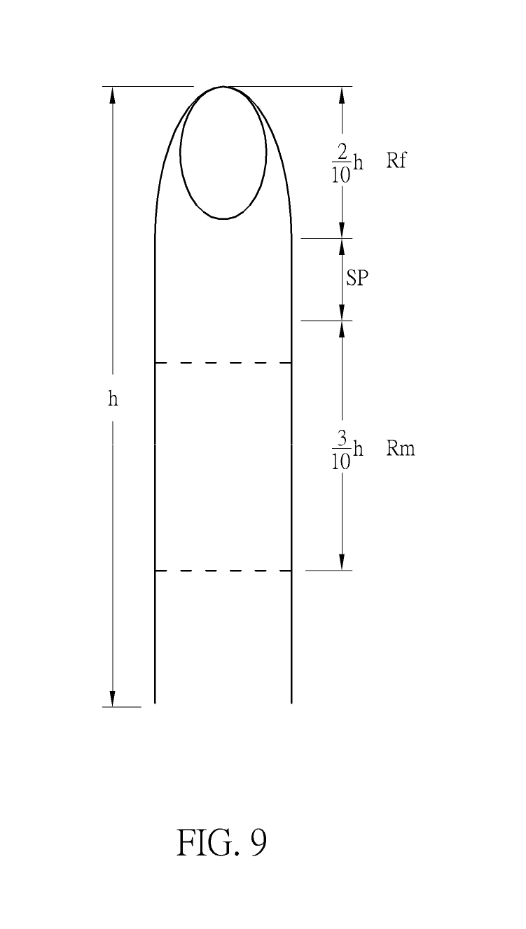

Many methods can be applied to define the front part region Rf and the middle part region Rm of the finger. In one embodiment, if the sensing length is h, setting xh length in most front part of the sensing length as the front part region Rf, and setting yh length after the front part region as the middle part region Rm. The x and the y are arithmetic numbers smaller than 1, wherein the summation of x plus y is less or equal to 1. Take FIG. 9 for example, if the sensing length of the finger is h, setting 2/10 h length in most front part of the sensing length as the front part region Rf, and setting 3/10 h length after the front part region as the middle part region Rm. Between the front part region Rf and the middle part region Rm, the space SP can exist or not exist.

Please note, in the embodiment of FIG. 5, the xh and the yh can be compared to a threshold/thresholds for determining if the determining mechanism in FIG. 5 should be activated or not. That is, in one embodiment, if the xh and the yh are not larger than a threshold value h_tip, all sensed touch controls are defined as normal touch controls. On the opposite, if at least one the xh and the yh is larger than a threshold value h_tip, the mechanism for determining the touch controls should be ignored or not based on the touch sensing amount ratio

$$\frac{S\_Rm}{S\_Rf}$$

is activated.

Please note, the above-mentioned embodiment can be applied to other objects besides the finger and other apparatuses besides the touch control mouse, thus the embodiments in FIG. 5 to FIG. 9 can be summarized as: an object state determining method, for determining a state for an object with respected to a touch sensing surface (ex. 101) of a touch control apparatus (ex. 100), which comprises: (a) computing a sensing length according to at least one touch sensing amount that the object causes to the sensing surface (ex. sensing lengths of sensing regions 503, 603, 703 and 803); (b) separating at least part of the sensing length to a front part region (ex. Rf) and a middle part region (ex. Rm); (c) computing a front part touch sensing amount for the front part region; (d) computing a middle part touch sensing amount for the middle part region; and (e) determining an object state of the object according to the front part touch sensing amount and the middle part touch sensing amount.

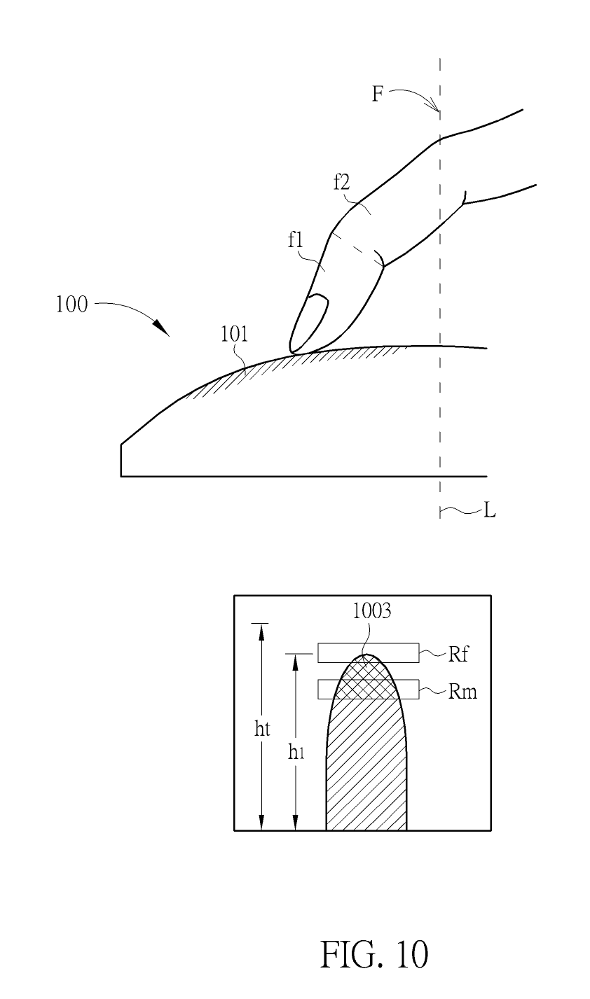

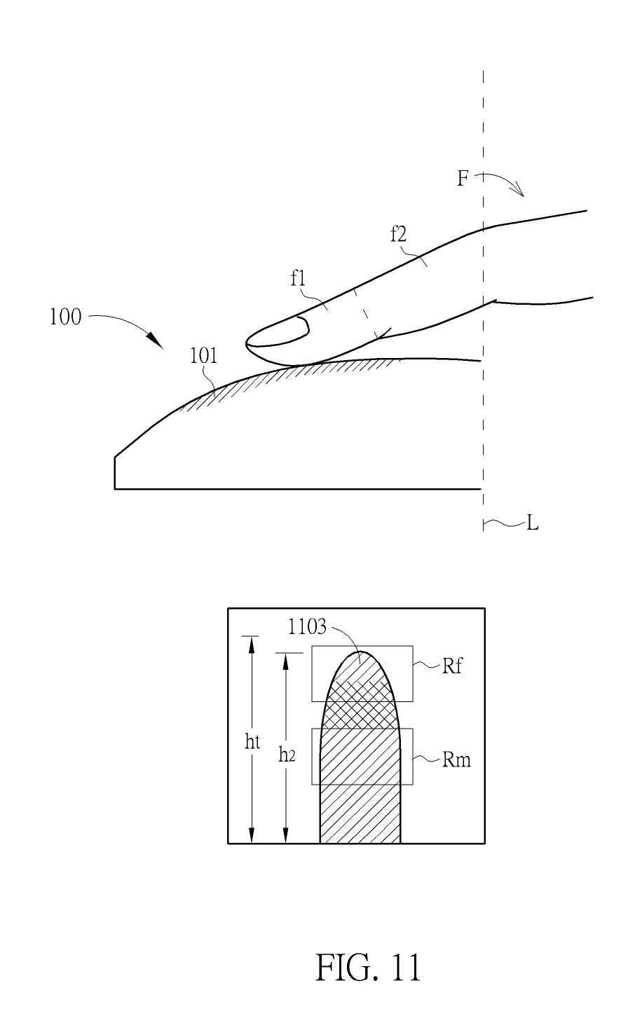

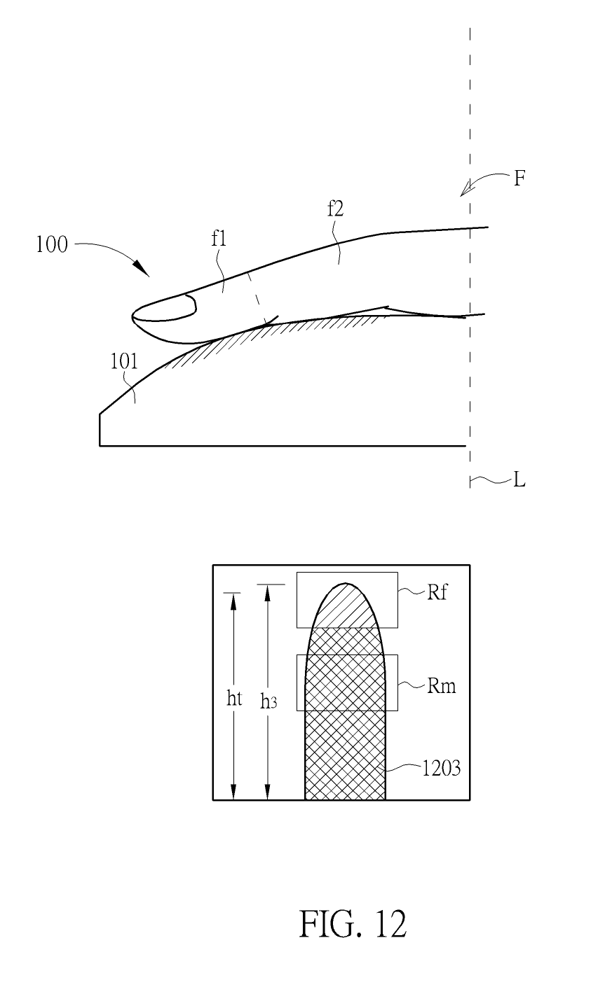

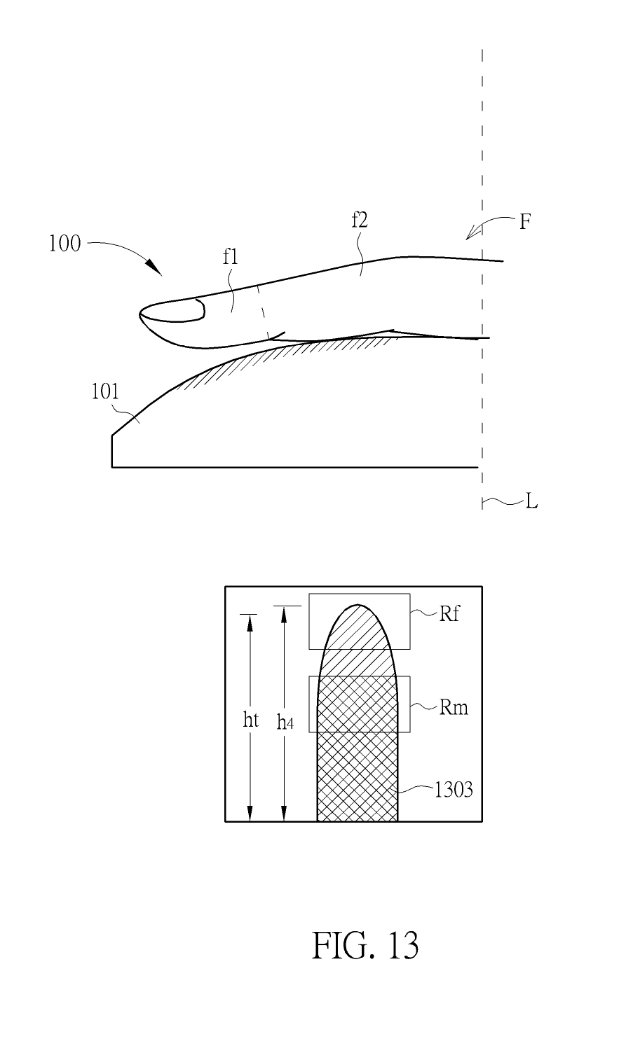

FIG. 10 to FIG. 13 are schematic diagrams illustrating a finger state detecting method according to another embodiment of the preset invention. The finger states in FIG. 10 to FIG. 13 are corresponding to which in FIG. 1 to FIG. 4, thus please refer decryptions related with FIG. 1 to FIG. 4 as well to understand the contents of FIG. 10 to FIG. 13. In this embodiment, the sensing length of the finger is computed and compared with a state threshold to determine a state of the finger. In the embodiments of FIG. 10 and FIG. 11, the sensing length h1 of the sensing region 1003 and the sensing length h2 of the sensing region 1013 are smaller than the state threshold length ht, thus the finger is determined to be in a touch control state. In the embodiment of FIG. 12, the sensing length h3 of the sensing region 1203 is larger than the state threshold length ht, thus the finger is determined to be in a non touch control state. In one embodiment, if it is determined that the finger is in a non touch control state with respect to the sensing surface, ignoring any touch control operation that the finger performs to the sensing surface in a predetermined time period for a timing that the object is determined in a touch control state with respect to the sensing surface. As above-mentioned, the wrong determination may occur in the process from FIG. 12 to FIG. 13 (the finger slips to a front end of the touch control mouse), or in the process from FIG. 13 to FIG. 12 (the finger slips to a rear end of the touch control mouse). Therefore, if the situation in FIG. 12 is set to a non touch control state following such mechanism, the wrong determination can be avoided.

In the state of FIG. 13, the sensing length h4 of the sensing region 1303 may be larger than the state threshold length ht or smaller than the state threshold length ht (in this embodiment, larger), thus the finger may be determined to be in the touch control state or in the non touch control state. Therefore, the state threshold length ht can be set to make sure if the example of FIG. 13 to be determined in the touch control state or in the non touch control state. Alternatively, the sensitivity for the sensing of the touch control mouse can be changed to control the example of FIG. 13 to be determined in the touch control state or in the non touch control state. For example, if the sensitivity is set to be larger, the finger will be sensed even if it is far away from the sensing surface, thus the example in FIG. 13 may have a longer sensing length. On the opposite, if the sensitivity is set to be smaller, the finger will not be sensed if it is not very close to the sensing surface, thus the example in FIG. 13 may have a shorter sensing length. Accordingly, the state threshold length ht or the sensitivity can be adjusted for different requirements. The embodiments in FIG. 5 to FIG. 8 can be performed simultaneously with the embodiments in FIG. 10 to FIG. 13, such that more accurate determination can be acquired.

Please note, the above-mentioned embodiment can be applied to other objects besides the finger and other apparatuses besides the touch control mouse, thus the embodiments in FIG. 10 to FIG. 13 can be summarized as: An object state determining method, for determining a state for an object with respected to a touch sensing surface of a touch control apparatus, which comprises: (a) computing a sensing length according to at least one touch sensing amount that the object causes to the sensing surface; (b) determining an object state of the object according to a relation between the sensing length and a state threshold length. Please note the embodiments in FIG. 5 to FIG. 8 can be performed simultaneously with the embodiments in FIG. 10 to FIG. 13, such that more accurate determination can be acquired.

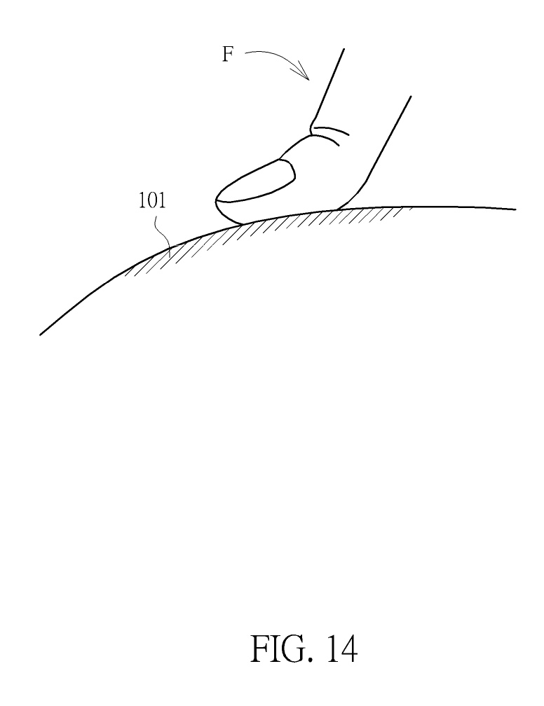

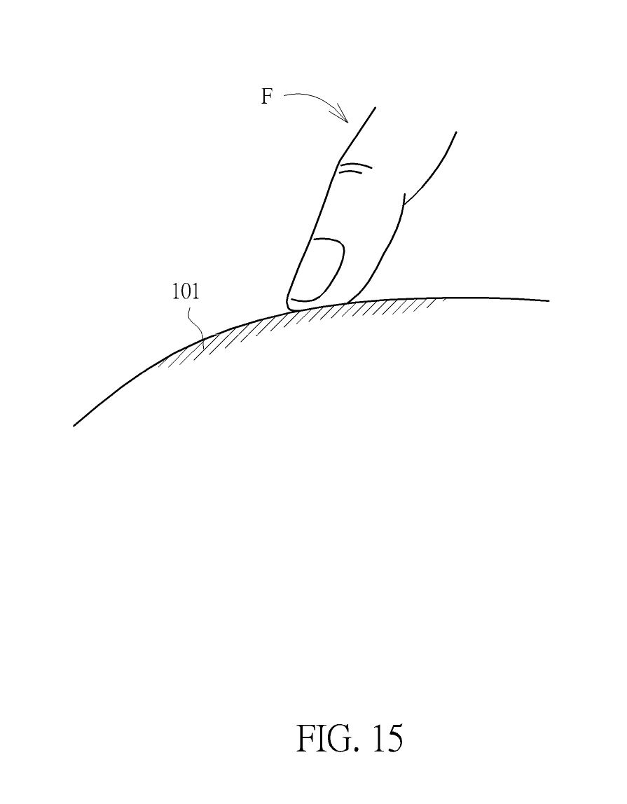

Besides above-mentioned embodiments, other situations that may cause wrong determination may exist. In the examples of FIG. 14 and FIG. 15, FIG. 14 illustrates that the fingertip initially presses the sensing surface 101, but the user tends to move the finger to the rear end of the touch control mouse, thus the finger is lifted. At the moment, the area size that the finger F presses the sensing surface 101 decreases, such that the computed barycenter moves toward but the finger F does not moves back yet, and the touch control mouse may wrongly determine that the finger F moves toward. In the normal case, if the finger F tends to move toward to the front end of the touch control mouse, the sensing area size should increase (ex. FIG. 5 to FIG. 7). Accordingly, if it has been detected that the finger F moves toward but the sensing area thereof decreases, the situations in FIG. 14 and FIG. 15 may occur. In one embodiment, if it has been detected that the finger F moves toward but the sensing area thereof decreases, the finger is determined to be in a non touch control state. Also, any touch control operation that the object performs to the sensing surface in a predetermined time period for a timing that the object is determined in a non touch control state, is ignored.

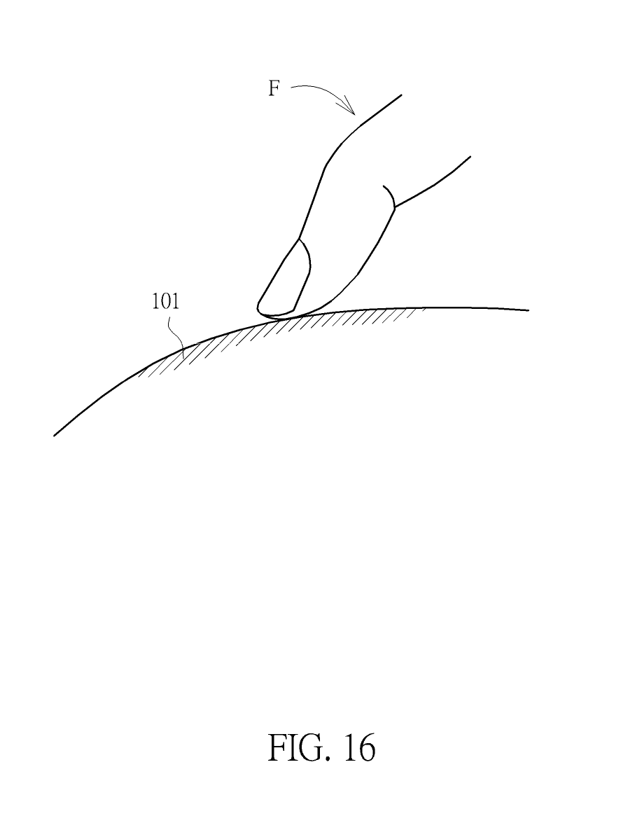

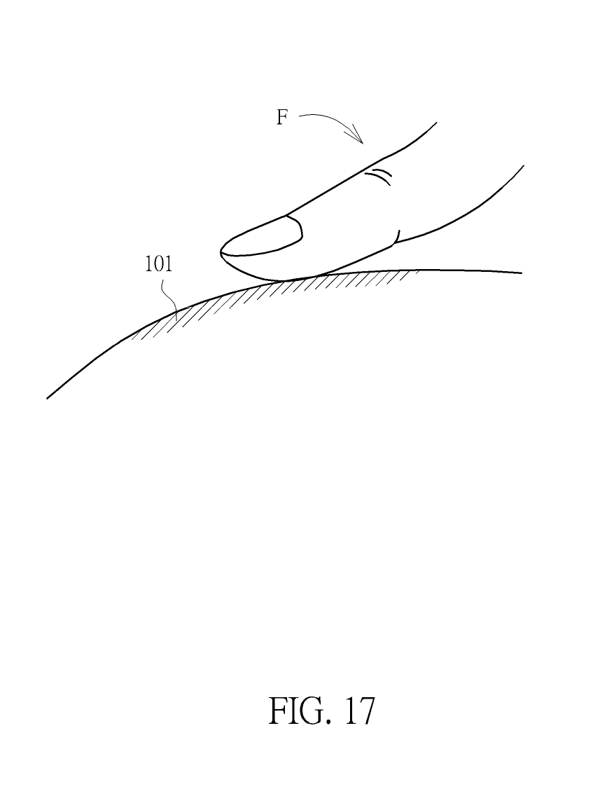

Similarly, if the finger F tends to move back to the rear end of the touch control mouse, the sensing area size is supposed to decrease (ex. FIG. 7 to FIG. 6 and then to FIG. 5). However, in FIG. 16, the user slightly presses the sensing surface 101 at the beginning, thus the finger F causes a smaller sensing area size. However, in FIG. 17, the user presses the sensing surface 101 harder, thus the finger F causes a larger sensing area size. In such case, the barycenter may move back, such that the finger is determined to move back. Accordingly, if it has been detected that the finger F moves back but the sensing area thereof increases, the situations in FIG. 16 and FIG. 17 may occur. In one embodiment, if it has been detected that the finger F moves back but the sensing area thereof increases, the finger is determined to be in a non touch control state. Also, any touch control operation that the object performs to the sensing surface in a predetermined time period for a timing that the object is determined in a non touch control state, is ignored.

Please note, the above-mentioned embodiment can be applied to other objects besides the finger and other apparatuses besides the touch control mouse, thus the embodiments in FIG. 14 to FIG. 17 can be summarized as: An object state determining method, for determining a state for an object with respected to a touch sensing surface of a touch control apparatus, comprising: (a) computing a first object region according to at least one first touch sensing amount that the object causes to the sensing surface (ex. 503-803 in FIG. 5 to FIG. 8); (b) computing a second object region according to at least one second touch sensing amount that the object causes to the sensing surface (ex. 503-803 in FIG. 5 to FIG. 8); (c) computing an object moving direction according to locations of the first object region and the second object region; and (d) determining an object state according to a relation between a size of the first object region, a size of the second object region, and the object moving direction.

If the first object region is generated earlier than the second object region, if the first object region is larger than the second object region, and if the object moving direction is toward a front end of the touch control apparatus (or to the fingertip), determining the object is in a non touch control state (ex. the embodiments in FIG. 14, FIG. 15). If the first object region is generated earlier than the second object region, if the first object region is smaller than the second object region, and if the object moving direction is toward a rear end of the touch control apparatus (or to the wrist), determining the object is in a non touch control state.

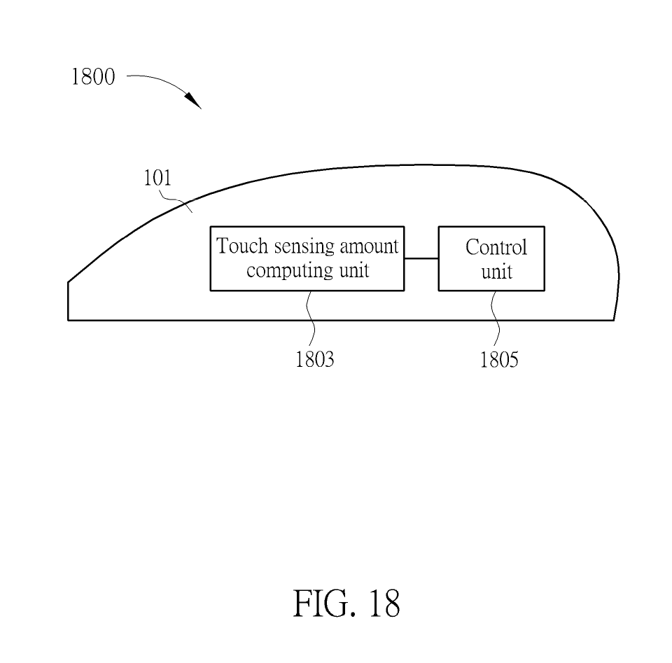

FIG. 18 is a block diagram illustrating a touch control apparatus according to one embodiment of the present invention. As illustrated in FIG. 18, the touch control apparatus 1800 comprises a sensing surface 1801, a touch sensing amount computing unit 1803 and a control unit 1805. The touch sensing amount computing unit 1803 is arranged to compute at least one touch sensing amount according to a distance between the object and the sensing surface 1801. The control unit 1805 is arranged to compute a sensing length, a moving state of the object or to determine an object state according to the touch sensing amount.

The apparatus in FIG. 18 can be applied to perform above-mentioned embodiments. For example, if it is applied to perform the embodiments in FIG. 5 to FIG. 8, the touch control apparatus can be summarized as: A touch control apparatus, which comprises: a sensing surface; a touch sensing amount computing unit, arranged to compute a touch sensing amount that the object causes to the sensing surface; a control unit, arranged to compute a sensing length according to the touch sensing amount, and for separating at least part of the sensing length to a front part region and a middle part region. The touch sensing amount computing unit further computes a front part touch sensing amount for the front part region and computes a middle part touch sensing amount for the middle part region, wherein the control unit determines an object state of the object according to a touch sensing amount ratio between the front part touch sensing amount and the middle part touch sensing amount. If it is applied to perform the embodiments in FIG. 10 to FIG. 13, the touch control apparatus can be summarized as: A touch control apparatus, comprising: a sensing surface; a touch sensing amount computing unit, arranged to compute a touch sensing amount that the object causes to the sensing surface; and a control unit, arranged to compute a sensing length according to the touch sensing amount, and arranged to determine an object state of the object according to a relation between the sensing length and a state threshold length. If it is applied to perform the embodiments in FIG. 14 to FIG. 17, the touch control apparatus can be summarized as: A touch control apparatus, comprising: a sensing surface; a touch sensing amount computing unit, arranged to compute a first touch sensing amount and a second touch sensing amount that the object causes to the sensing surface; a control unit, arranged to computing an object moving direction according to locations of the first object region and the second object region, and arranged to determine an object state according to a relation between a size of the first object region, a size of the second object region, and the object moving direction.

In one embodiment, the touch control apparatus is a capacitance type touch control apparatus, thus the above-mentioned touch sensing amounts are capacitance variation values. In another embodiment, the touch control apparatus is an optical touch control apparatus, thus the above-mentioned touch sensing amounts are brightness values.

Other detail steps have been detailedly illustrated in above-mentioned embodiments, thus are omitted for brevity here.

In view of above-mentioned embodiments, the issue for wrongly determining the object state can be avoided. Also, different sensitivities can be set for above-mentioned embodiments, thus the issue for wrongly determining the object state can be avoided more effectively.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An object state determining method, for determining a state for an object with respected to a touch sensing surface of a touch control apparatus, comprising:
(a) computing a sensing length according to at least one touch sensing amount that the object causes to the sensing surface;
(b) separating at least part of the sensing length to a front part region and a middle part region;
(c) computing a front part touch sensing amount for the front part region;
(d) computing a middle part touch sensing amount for the middle part region; and
(e) determining an object state of the object according to the front part touch sensing amount and the middle part touch sensing amount.

2. The object state determining method of claim 1, wherein the step (e) comprises determining the object state of the object according to a touch sensing amount ratio between the front part touch sensing amount and the middle part touch sensing amount.

3. The object state determining method of claim 2, wherein the step (e) comprises:
if the touch sensing amount ratio is larger than a state threshold value, determining the object is in a non touch control state with respect to the sensing surface; and
if the touch sensing amount ratio is smaller than the state threshold value, determining the object is in a touch control state with respect to the sensing surface.

4. The object state determining method of claim 3, further comprising:
if it is determined that the object is in a non touch control state with respect to the sensing surface, ignoring any touch control operation that the object performs to the sensing surface in a predetermined time period for a timing that the object is determined in a non touch control state with respect to the sensing surface.

5. The object state determining method of claim 1, wherein the object is a finger, the front part comprises a fingertip, the middle part comprises at least part for finger sections which are not the fingertip.

6. The object state determining method of claim 1, wherein the touch control apparatus is a capacitance type touch control apparatus, wherein the touch sensing amount, the front part touch sensing amount and the middle part touch sensing amount are capacitance variation values, wherein the front part touch sensing amount comprises at least one assemble for capacitance sensing amounts, and the middle part touch sensing amount comprises at least one assemble for capacitance sensing amounts.

7. The object state determining method of claim 1, wherein the touch control apparatus is an optical touch control apparatus, wherein the front part touch sensing amount, the middle part touch sensing amount and the rear part touch sensing amount are brightness values.

8. The object state determining method of claim 1, wherein the step (b) comprises:
if the sensing length is h, setting xh length in most front part of the sensing length as the front part region, and setting yh length after the front part region as the middle part region, wherein the x and the y are arithmetic numbers smaller than 1, wherein a summation of the x plus the y is smaller than or equals 1.

9. An object state determining method, for determining a state for an object with respected to a touch sensing surface of a touch control apparatus, comprising:
(a) computing a sensing length according to at least one touch sensing amount that the object causes to the sensing surface;
(b) determining an object state of the object according to a relation between the sensing length and a state threshold length.

10. The object state determining method of claim 9, wherein the step (b) comprises:
if the sensing length is larger than the state threshold length, determining the object is in a non touch control state with respect to the sensing surface; and
if the sensing length is smaller than the state threshold length, determining the object is in a touch control state with respect to the sensing surface.

11. The object state determining method of claim 10, further comprising:
if it is determined that the object is in a non touch control state with respect to the sensing surface, ignoring any touch control operation that the object performs to the sensing surface in a predetermined time period for a timing that the object is determined in a non touch control state with respect to the sensing surface.

12. The object state determining method of claim 9, wherein the object is a finger.

13. The object state determining method of claim 9, wherein the touch control apparatus is a capacitance type touch control apparatus, wherein the touch sensing amount are capacitance variation values, wherein the touch sensing amount comprises at least one assemble for capacitance sensing amounts.

14. The object state determining method of claim 9, wherein the touch control apparatus is an optical touch control apparatus, and the touch sensing amount is a brightness value.

15. An object state determining method, for determining a state for an object with respected to a touch sensing surface of a touch control apparatus, comprising:
(a) computing a first object region according to at least one first touch sensing amount that the object causes to the sensing surface;
(b) computing a second object region according to at least one second touch sensing amount that the object causes to the sensing surface;
(c) computing an object moving direction according to locations of the first object region and the second object region; and
(d) determining an object state according to a relation between a size of the first object region, a size of the second object region, and the object moving direction.

16. The object state determining method of claim 15, wherein the step (d) comprises: determining if the object is in a touch state or in a non touch state with respect to the touch sensing surface, according to a relation between the first object region, the second object region, and the object moving direction.

17. The object state determining method of claim 16, wherein if the first object region is generated earlier than the second object region, if the first object region is larger than the second object region, and if the object moving direction is toward a front end of the touch control apparatus, determining the object is in a non touch control state.

18. The object state determining method of claim 16, wherein if the first object region is generated earlier than the second object region, if the first object region is smaller than the second object region, and if the object moving direction is toward a rear end of the touch control apparatus, determining the object is in a non touch control state.

19. The object state determining method of claim 16, further comprising:
if it is determined that the object is in a non touch control state with respect to the sensing surface, ignoring any touch control operation that the object performs to the sensing surface in a predetermined time period for a timing that the object is determined in a non touch control state with respect to the sensing surface.

20. The object state determining method of claim 16, wherein the object is a finger.

21. The object state determining method of claim 20, wherein the object moving direction is toward a fingertip.

22. The object state determining method of claim 20, wherein the object moving direction is toward a wrist.

23. The object state determining method of claim 15, wherein the touch control apparatus is a capacitance type touch control apparatus, wherein the first touch sensing amount and the second touch sensing amount are capacitance variation values, wherein the first touch sensing amount and the second touch sensing amount comprise at least one assemble for capacitance sensing amounts.

24. The object state determining method of claim 15, wherein the touch control apparatus is an optical touch control apparatus, wherein the first touch sensing amount and the second touch sensing amount are brightness values.

25. A touch control apparatus, comprising:
a sensing surface;
a touch sensing amount computing unit, arranged to compute a touch sensing amount that the object causes to the sensing surface;
a control unit, arranged to compute a sensing length according to the touch sensing amount, and for separating at least part of the sensing length to a front part region and a middle part region;
wherein the touch sensing amount computing unit further computes a front part touch sensing amount for the front part region and computes a middle part touch sensing amount for the middle part region, wherein the control unit determines an object state of the object according to the front part touch sensing amount and the middle part touch sensing amount.

26. The touch control apparatus of claim 25, wherein the control unit further determines the object state of the object according to a touch sensing amount ratio between the front part touch sensing amount and the middle part touch sensing amount.

27. The touch control apparatus of claim 26,
wherein if the touch sensing amount ratio is larger than a state threshold value, the control unit determines the object is in a non touch control state with respect to the sensing surface; and
wherein if the touch sensing amount ratio is smaller than the state threshold value, the control unit determines the object is in a touch control state with respect to the sensing surface.

28. The touch control apparatus of claim 27, further comprising:
if the control unit determines that the object is in a non touch control state with respect to the sensing surface, the control unit ignores any touch control operation that the object performs to the sensing surface in a predetermined time period for a timing that the object is determined in a non touch control state with respect to the sensing surface.

29. The touch control apparatus of claim 25, wherein the object is a finger, the front part comprises a fingertip, the middle part comprises at least part for finger sections which are not the fingertip.

30. The touch control apparatus of claim 25, wherein the touch control apparatus is a capacitance type touch control apparatus, wherein the touch sensing amount, the front part touch sensing amount and the middle part touch sensing amount are capacitance variation values, wherein front part touch sensing amount comprises at least one assemble for capacitance sensing amounts, and the middle part touch sensing amount comprises at least one assemble for capacitance sensing amounts.

31. The touch control apparatus of claim 25, wherein the touch control apparatus is an optical touch control apparatus, wherein the front part touch sensing amount, the middle part touch sensing amount and the rear part touch sensing amount are brightness values.

32. The touch control apparatus of claim 25, wherein if the sensing length is h, the control unit sets xh length in most front part of the sensing length as the front part region, and sets yh length after the front part region as the middle part region, wherein the x and the y are arithmetic numbers smaller than 1, wherein a summation of the x plus the y is smaller or equals to 1.

33. A touch control apparatus, comprising:
a sensing surface;
a touch sensing amount computing unit, arranged to compute a touch sensing amount that the object causes to the sensing surface; and
a control unit, arranged to compute a sensing length according to the touch sensing amount, and arranged to determine an object state of the object according to a relation between the sensing length and a state threshold length.

34. The touch control apparatus of claim 33,
wherein if the sensing length is larger than the state threshold length, the control unit determines the object is in a non touch control state with respect to the sensing surface; and
wherein if the sensing length is smaller than the state threshold length, the control unit determines the object is in a touch control state with respect to the sensing surface.

35. The touch control apparatus of claim 34, wherein if the control unit determines that the object is in a non touch control state with respect to the sensing surface, the control unit ignores any touch control operation that the object performs to the sensing surface in a predetermined time period for a timing that the object is determined in a non touch control state with respect to the sensing surface.

36. The touch control apparatus of claim 35, wherein the object is a finger.

37. The touch control apparatus of claim 33, wherein the touch control apparatus is a capacitance type touch control apparatus, wherein the touch sensing amount are capacitance variation values, wherein the touch sensing amount comprises at least one assemble for capacitance sensing amounts.

38. The object state determining method of claim 33, wherein the touch control apparatus is an optical touch control apparatus, wherein the first touch sensing amount and the second touch sensing amount are brightness values.

39. A touch control apparatus, comprising:
a sensing surface;
a touch sensing amount computing unit, arranged to compute a first touch sensing amount and a second touch sensing amount that the object causes to the sensing surface;
a control unit, arranged to computing an object moving direction according to locations of the first object region and the second object region, and arranged to determine an object state according to a relation between a size of the first object region, a size of the second object region, and the object moving direction.

40. The touch control apparatus of claim 39, wherein the control unit further determines if the object is in a touch state or in a non touch state with respect to the touch sensing surface, according to a relation between the first object region, the second object region, and the object moving direction.

41. The touch control apparatus of claim 40, wherein if the first object region is generated earlier than the second object region, if the first object region is larger than the second object region, and if the object moving direction is toward a front end of the touch control apparatus, the control unit determines the object is in a non touch control state.

42. The touch control apparatus of claim 40, if the control unit determines that the object is in a non touch control state with respect to the sensing surface, the control unit ignores any touch control operation that the object performs to the sensing surface in a predetermined time period for a timing that the object is determined in a non touch control state with respect to the sensing surface.

43. The touch control apparatus of claim 40, wherein if the first object region is generated earlier than the second object region, if the first object region is smaller than the second object region, and if the object moving direction is toward a rear end of the touch control apparatus, the control unit determines the object is in a non touch control state.

44. The touch control apparatus of claim 39, wherein the object is a finger.

45. The touch control apparatus of claim 44, wherein the object moving direction is toward a fingertip.

46. The touch control apparatus of claim 44, wherein the object moving direction is toward a wrist.

47. The touch control apparatus of claim 39, wherein the touch control apparatus is a capacitance type touch control apparatus, wherein the first touch sensing amount and the second touch sensing amount are capacitance variation values, wherein the first touch sensing amount and the second touch sensing amount comprise at least one assemble for capacitance sensing amounts.

48. The touch control apparatus of claim 39, wherein the touch control apparatus is an optical touch control apparatus, wherein the first touch sensing amount and the second touch sensing amount are brightness values.
